(19) United States
(12) Patent Application Publication
(10) Pub. No.: US 2003/0051362 A1
(43) Pub. Date: Mar. 20, 2003

(54) Incision template and methods for use

(76) Inventors: Robert F. Buckman, Radnor, PA (US); Rodney A. Brenneman, San Juan Capistrano, CA (US); Reynaldo B. Halili JR., Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/953,410

(22) Filed: Sep. 14, 2001

(51) Int. Cl. B43L 13/20

(52) U.S. Cl. 33/566; 33/512

(57) ABSTRACT

The present invention provides templates, methods, and kits for locating a site on a patient's chest suitable for establishing percutaneous intercostal access to the patient's heart. In particular, the present invention provides templates, methods, and kits which effectively and rapidly locate an incision site for intercostal access by sharp and/or blunt dissection for subsequent placement of minimally invasive direct cardiac massagers, chest tubes, defibrillation electrodes, and the like. An incision template according to the present invention comprises a structure placeable on a patient's chest. The structure has at least one marker which can be aligned with at least one anatomical feature of the patient and a target zone which lies over a preselected location for intercostal access when the marker is aligned with the anatomical feature.

### BACKGROUND OF THE INVENTION

1. Field of the Invention

The present invention relates generally to medical devices and methods. More particularly, the present invention relates to devices, methods, and kits for locating a site on a patient's chest suitable for establishing percutaneous intercostal access to the patient's heart for subsequent placement of minimally invasive direct cardiac massagers, chest tubes, defibrillation electrodes, and the like.

Sudden cardiac arrest is a leading cause of death in most industrial societies. In order to resuscitate a victim of cardiac arrest, it is necessary to provide an adequate artificial circulation of blood to oxygenate the heart and brain by re-establishing the pumping function of the heart during the period between cardiac arrest and restoration of normal cardiac activity. Such a cardiac pumping function must be instituted at the earliest possible state. While in many cases it is theoretically possible to re-establish cardiac function, irreversible damage to vital organs, particularly the brain and the heart itself, will usually occur if sufficient blood flow is not re-established within a critical period of time from the moment of cardiac arrest. Such a period of time is measured ranging between four and six minutes.

A number of techniques have been developed to provide artificial circulation of blood to oxygenate the heart and brain during the period between cardiac arrest and restoration of normal cardiac activity. Prior to the 1960's, open chest cardiac massage (OCM) was a standard treatment for sudden cardiac arrest. Open chest cardiac massage, as its name implies, involved opening a patient's chest and manually squeezing the heart to pump blood to the body. In the 1960's, closed chest cardiac massage (CCM) where the heart is externally compressed through the chest wall became the standard of treatment. When CCM is combined with airway support, it is known as cardiopulmonary resuscitation (CPR). CPR has the advantage that it is much less invasive than OCM and can be performed by less skilled individuals. It has the disadvantage, however, that it is not generally effective. In particular, the medical literature shows that CCM provides significantly less cardiac output, neuroperfusion, and cardiac perfusion than achieved with OCM.

Of particular interest to the present invention is the recent introduction of devices for performing minimally invasive direct cardiac massage. Such devices and methods are described in co-pending application nos. 09/087,665 filed May 29, 1998, now U.S. Pat. No. 6,200,280; 60/111,934 filed Dec. 11, 1998 (now abandoned); 09/344,440 filed Jun. 25, 1999; 09/356,064 filed Jul. 19, 1999; 09/801,421 filed Mar. 7, 2001; and 09/898,701 filed Jul. 2, 2001, assigned to the assignee of the present application. The full disclosures of each of these prior patents and/or applications are incorporated herein by reference. Generally, such methods rely on introducing a plurality of struts, an expansible flared bell structure, a laterally oriented expansible structure, or other expandable member to engage the heart through a small incision through an intercostal space to a region over the pericardium or other heart surface. The heart may then be pumped by directly engaging the deployed expansible structure against the pericardium to repeatably compress the heart, typically by reciprocating a shaft attached to the member. Additional minimally invasive direct cardiac massage devices and methods are also described in 5,582,580; 5,571,074; and 5,484,391 issued to Buckman, Jr. et al. and U.S. Pat. Nos. 5,931,850; 5,683,364; and 5,466,221 issued to Zadini et al., licensed to the assignee of the present application. While direct cardiac massage approaches offer great promise, certain shortcomings still exist. For example, it is sometimes difficult to locate a site on a patient's chest suitable for establishing percutaneous intercostal access to the patient's heart, particularly by less skilled treating individuals. Misplacement of an access site could lead to serious risks that may be life threatening, such as puncturing and/or lacerating an organ, blood vessel (e.g. internal mammary artery), or surrounding structure.

For these reasons, it would be desirable to provide devices, methods, and kits for locating a site on a patient's chest suitable for establishing percutaneous intercostal access to the patient's heart. In particular, it would be desirable to provide devices, methods, and kits which effectively and rapidly locate an incision site for intercostal access by sharp and/or blunt dissection for subsequent placement of minimally invasive direct cardiac massagers, chest tubes, defibrillation electrodes, and the like. The devices, methods, and kits may be used by persons of minimal experience or training. The devices, methods, and kits should be simple and less costly to manufacture and produce. At least some of these objectives will be met by the invention described hereinafter.

2. Description of the Background Art

Devices and methods for minimally invasive direct cardiac massage through intercostal dissection are described co-pending U.S. patent application Ser. No. 09/087,665 filed May 29, 1998, now U.S. Pat. No. 6,200,280; U.S. Provisional Patent Application No. 60/111,934 filed Dec. 11, 1998 (now abandoned); U.S. patent application Ser. Nos. 09/344,440 filed Jun. 25, 1999; 09/356,064 filed Jul. 19, 1999; 09/801,421 filed Mar. 7, 2001; 09/895,844 filed Jun. 29, 2001; and 09/898,701 filed Jul. 2, 2001, assigned to the assignee of the present application. U.S. Pat. Nos. 5,484,3915, 582,580; and 5,571,074 to Buckman, Jr. et al. and U.S. Pat. Nos. 5,466,221 and 5,683,364 to Zadini et al., licensed to the assignee of the present application, also describe devices and methods for minimally invasive direct cardiac massage through an intercostal space. Devices and methods for establishing intercostal access are described in co-pending U.S. patent application Ser. No. 09/768,041 filed Jan. 22, 2001, assigned to the assignee of the present application. U.S. Pat. No. 3,496,932 describes a sharpened stylet for introducing a cardiac massage device to a space between the sternum and the heart. Dissectors employing inflatable components are described in U.S. Pat. Nos. 5,730,756; 5,730,748; 5,716,325; 5,707,390; 5,702,417; 5,702,416; 5,694,951; 5,690,668; 5,685,826; 5,667,520; 5,667,479; 5,653,726; 5,624,381; 5,618,287; 5,607,443; 5,601,590; 5,601,589; 5,601,581; 5,593,418; 5,573,517; 5,540,71 1; 5,514,153; and 5,496,345.

The full disclosures of each of the above references are incorporated herein by reference.

### BRIEF SUMMARY OF THE INVENTION

The present invention provides templates, methods, and kits for locating a site on a patient's chest suitable for establishing percutaneous intercostal access to the patient's heart. In particular, the present invention provides templates, methods, and kits which effectively and rapidly locate an incision site for intercostal access by sharp and/or blunt dissection for subsequent placement of minimally invasive direct cardiac massagers, chest tubes, defibrillation electrodes, and the like. Moreover, the present invention may be used by persons of minimal skill or training.

In a first aspect of the present invention, an incision template comprises a structure placeable on a patient's chest. The structure has at least one marker which can be aligned with at least one anatomical feature of the patient and a target zone which lies over a preselected location for intercostal access when the marker is aligned with the anatomical feature. The structure may comprise a card structure, wire structure, or other framework which is suitable for locating a site on a patient's chest for establishing intercostal access to the patient's heart. Preferably, the structure will have a credit card shape which has a width in the range from 1 inch to 3 inches, a length in the range from 3 inches to 5 inches, and a thickness in the range from 0.005 inch to 0.050 inch, and be formed from plastic, metal, rubber, wire, or like materials. In some circumstances, a set of templates having various shapes, sizes, and/or dimensions may be provided to accommodate different patient characteristics.

The template will typically have two markers which together define the preselected location for intercostal access (i.e. horizontal and vertical placement). The template marker may comprise an edge, hole, or line on the structure. For example, a line may be placed across a transparent or translucent template that allows a treating person easily align the marker with the anatomical feature. The marker is alignable with an anatomical feature, such as, a mid-line of a sternum, an intercostal space, a rib (e.g. forth or fifth rib), or a nipple. The template target zone (which may also serve as a marker) may comprise an opening, groove, notch, or slit in the structure which lies preferably over a skin surface over a fourth intercostal space when the marker is aligned with the anatomical feature.

In a preferred embodiment, the incision template comprises a credit card structure which has a left edge which can be aligned with a mid-line of a sternum and a template opening which lies over a fourth intercostal space. The template opening will preferably have a cross-like pattern, wherein a first axis of the structure opening crosses with a second axis of the structure opening to define an incision point for subsequent entry. The template opening may alternatively have a T-bar pattern, or any other opening pattern which serves to define a horizontal incision boundary. In this case, the second axis may intersect with the first axis to define the incision boundary. Hence, the second axis may define either an incision point or an incision boundary at its intersection with the first axis. Furthermore, the structure opening may have more than one intersecting axis (i.e. a third axis) such that both the incision point and incision boundary are defined. Such a horizontal boundary allows users of the present invention to easily and effectively know how close to the mid-line sternum should the preferred location for intercostal access be positioned without any risks of unintended damage of blood vessels, such as the internal mammary artery, organs, or any other surrounding structures. Typically, the horizontal incision boundary will be in a range from about 2.5 cm to about 7.5 cm away from the mid-line sternum.

In some embodiments, the incision template may additionally comprise a detachable adhesive skin contacting surface which may be a part of a back or bottom side of the structure. The adhesive skin contacting surface will typically be pre-marked and form a patch around tissue at the access site to maintain near normal inter-thoracic pressure after 5 intercostal access.

In a second aspect of the present invention, an incision template for locating a site of percutaneous intercostal access comprises a flat-sided body having an opening extending between opposite flat sides of the body. The body is positionable against a skin surface of an intercostal space so that the opening defines the site suitable for subsequent intercostal access.

In a third aspect of the present invention, methods for locating a site on a patient's chest suitable for establishing percutaneous intercostal access to the patient's heart are provided. One method comprises aligning at least one marker on a template with at least one anatomical feature of the patient, the template having a target zone which lies over the site when the marker is aligned with the anatomical feature. Aligning comprises aligning a first marker with a mid-line of the patient's sternum and aligning a second marker with a fourth intercostal space. Preferably, a left edge of the template is aligned with a sternum mid-line and a template opening over a fourth intercostal space. In the case where a set of cards having various shapes, sizes, and/or dimensions are provided, a user may choose a particular template dependent upon patient characteristics prior to alignment. Furthermore, the template opening (which may serve as both a marker and a target zone) may define a horizontal incision boundary and/or an incision point for subsequent entry. This incision point will typically be located between a fourth and fifth rib of the patient, left of the mid-line sternum.

The access site on the patient's chest as defined by the target zone on the template may be appropriately marked by a treating person with a surgical marker. Optionally, a pre-marked adhesive skin contacting surface on the back or bottom side of the template may be detached on the site so that there is no need to mark the site with a surgical marker. Additionally, the adhesive skin contacting surface may form an access patch around the site after intercostal access. The incision site and surrounding area may then be prepped using antiseptic, a dispenser cup, gauze, and/or procedure drape. Intercostal access may then be achieved by sharp dissection, blunt dissection, or preferably by a combination of sharp and blunt dissection, wherein a cutting element may be advanced through the site defined by the target zone so as to make a small incision or thoracostomy through the skin overlying an intercostal space and then advancing a blunt member through the intercostal space above the heart. The cutting element may comprise a scalpel, surgical knife, lancet, blade, and the like. The blunt member may comprise a gloved finger of a treating person, a blunt shaft or support, or like structure for clearing access to the heart and verifying the location of the heart. Following intercostal access establishment, a direct cardiac massage device may be advanced. Exemplary cardiac massage devices are described in co-pending U.S. patent application Ser. No. 09/087,665 filed May 29, 1998, now U.S. Pat. No. 6,200,280; U.S. Provisional Patent Application No. 60/111,934 filed Dec. 11, 1998 (now abandoned); U.S. patent application Ser. Nos. 09/344,440 filed Jun. 25, 1999; 09/356,064 filed Jul. 19, 1999; 09/801,421 filed Mar. 7, 2001; and 09/898,701 filed Jul. 2, 2001, assigned to the assignee of the present application. Other suitable cardiac massage structures are described in U.S. Pat. Nos. 5,484,391; 5,582,580; and 5,571,074 issued to Buckman, Jr. et al. and 5,931,850; 5,683,364; and 5,466,221 issued to Zadini et al., licensed to the assignee of the present application.

In a fourth aspect of the present invention, another method for locating a site on a patient's chest suitable for establishing percutaneous intercostal access to the patient's heart is provided. The method comprises aligning a left edge of a template with a mid-line of the patient's sternum and aligning an opening in the template with a fourth intercostal space so that a target zone of the template lies over the site following alignment of the template.

In a fifth aspect of the present invention, an improved method for establishing intercostal access to a patient's heart is provided. The improvement comprises aligning a template with an anatomical feature of the patient and penetrating an instrument through tissue between the patient's ribs at a site determined by the template.

In a sixth aspect of the present invention, kits comprising a template and instruction for use are provided. The template may comprise any of the structures described herein, while instructions for locating a site on a patient's chest suitable for establishing percutaneous intercostal access to the patient's heart will generally recite the steps for performing one or more of the above described methods. A conventional package, which may be in the form of a bag, pouch, box, sealable tray, or the like, may be used to contain the template and the instructions for use. The kit may further comprise a first tray, holding the incision template and a cardiac massage device, and a second tray, holding at least a surgical marking pen, scalpel, gauze, dispenser cup, procedure drape, clear view guard, or chest seal. The first and second tray may be hinged together to form a single unit, wherein a tray handle is integrally formed with the first or second tray. Optionally, but not necessarily, all tray components may be sterilized. The first and second tray components may further be independently sterilizable. The kit may alternatively further comprise a single sterile tray holding at least the template, a surgical marking pen, a scalpel, a cardiac massage device, gauze, a dispenser cup, a procedure drape, clear view guard, or chest seal. Still optionally, the template and a surgical marking pen may be provided outside the sterile tray in the package or bag. The instructions will often be printed, optionally being at least in-part disposed on packaging. The instructions may alternatively comprise a videotape, a CD-ROM or other machine readable code, a graphical representation, or the like showing any of the above described methods.

A further understanding of the nature and advantages of the present invention will become apparent by reference to the remaining portions of the specification and drawings.

### BRIEF DESCRIPTION OF THE DRAWINGS

FIGS. 1A-1D illustrate an exemplary device for locating a site on a patient's chest suitable for establishing percutaneous intercostal access constructed in accordance with the principles of the present invention.

FIGS. 2A-2C illustrate an alternative embodiment of the device of the present invention, showing an incision template with a T-bar opening.

FIGS. 3 and 4 illustrate still further embodiments of the device of the present invention.

FIG. 5 is a cross-sectional view illustrating a heart underneath a patient's ribs.

FIGS. 6A-6E illustrate a method according to the present invention employing the device of FIG. 1.

FIG. 7 is a perspective view of a cardiac massage device used in conjunction with the present invention.

FIG. 8 illustrates a distal end of the cardiac massage device of FIG. 7, showing a deployed flared bell structure.

FIG. 9 illustrates a kit according to the present invention comprising an incision template and instructions for use.

FIG. 10 illustrates a sterile tray that may be enclosed within the packaging of the kit of FIG. 9.

FIGS. 11A and 11B illustrate an alternative tray unit that may be enclosed within the packaging of the kit of FIG. 9.

### DETAILED DESCRIPTION OF THE INVENTION

The present invention provides templates, methods, and kits for locating a site on a patient's chest suitable for establishing percutaneous intercostal access to the patient's heart. In particular, the present invention provides templates, methods, and kits which effectively and rapidly locate an incision site for intercostal access by sharp and/or blunt dissection for subsequent placement of minimally invasive direct cardiac massagers, chest tubes, defibrillation electrodes, and the like.

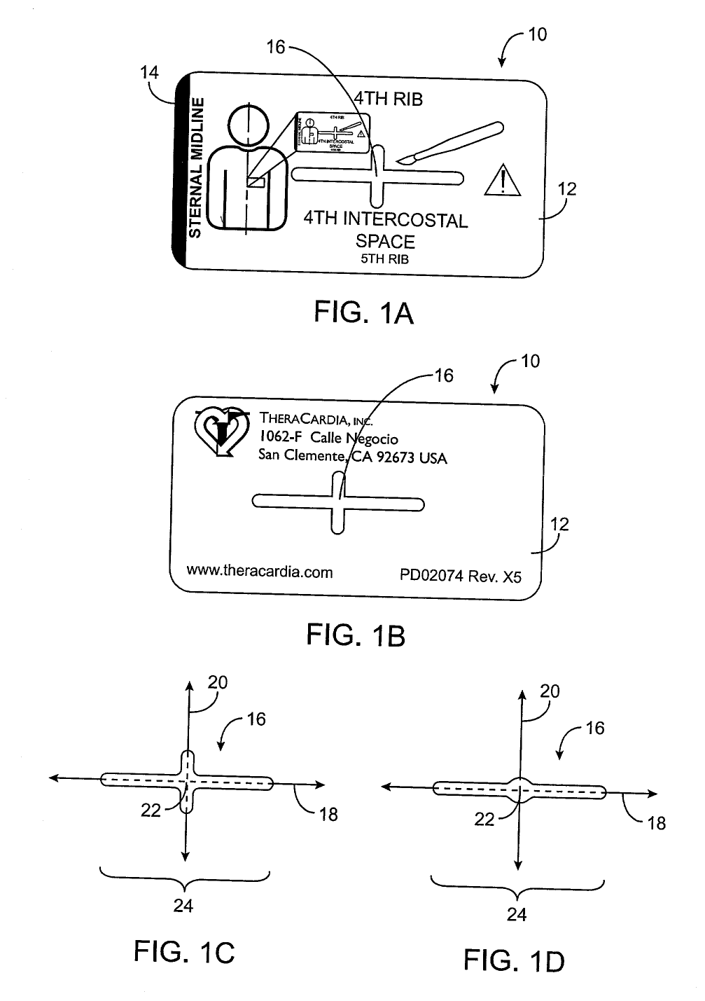

Referring now to FIGS. 1A and 1B, an exemplary incision template 10 constructed in accordance with the principles of the present invention for locating a site on a patient's chest suitable for establishing percutaneous intercostal access to the patient's heart is illustrated. The incision template 10 comprises a structure 12 placeable on a patient's chest. The structure 12 has at least one marker 14 which can be aligned with at least one anatomical feature of the patient. The structure 12 also has a target zone 16 which lies over a preselected location for intercostal access when the marker 14 is aligned with the anatomical feature. As discussed above, the incision template 10 effectively and rapidly locates an incision site and may be used by persons of minimal skill or training. It will be appreciated that the following depictions are for illustration purposes only and does not necessarily reflect the actual shape, size, or dimension of the incision template 10. This applies to all depictions hereinafter.

Preferably, the structure 12 comprises a flat sided body having a credit card structure which has a width in the range from 1 inch to 3 inches, a length in the range from 3 inches to 5 inches, and a thickness in the range from 0.005 inch to 0.050 inch. In some instances, a set of cards having various shapes, sizes, and/or dimensions may be provided to accommodate different size patients. The structure 12 may be formed from a variety of materials, including plastic, metal, rubber, wire, or like materials.

The structure 12 will typically have two markers which together define the preselected location for intercostal access (i.e. horizontal and vertical placement). The template marker 14 may comprise an edge, hole, or line on the structure. As shown in FIG. 1A, a line 14 may be placed across the incision template 10 so as to facilitate easy alignment of the marker 14 with the anatomical feature. The marker 14 is alignable with an anatomical feature, such as, a mid-line of a sternum and/or an intercostal space between the forth and fifth ribs (i.e. fourth intercostal space). The template target zone 16 (which also serves as a marker) preferably comprises an opening extending between opposite flat sides of the body 12, as depicted in FIGS. 1A and 1B, which lies over a skin surface over a fourth intercostal space. As shown in FIG. 1C, the template opening 16 will preferably have a cross-like pattern, wherein a first axis 18 of the structure opening crosses with a second axis 20 of the structure opening to define an incision point 22 for subsequent entry. FIG. 1D illustrates yet another cross-like pattern for the template opening 16.

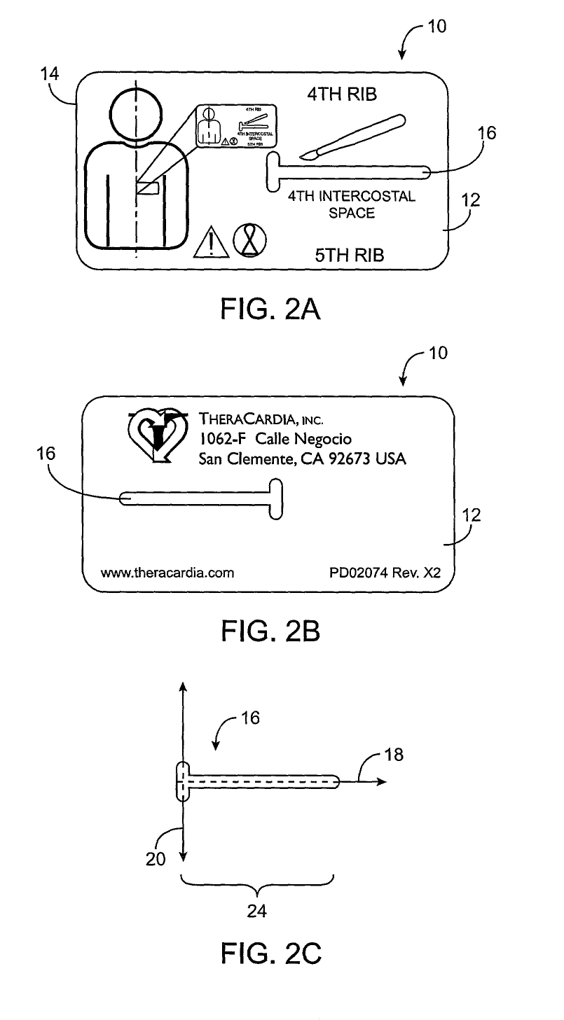

Referring now to FIGS. 2A and 2B, the template opening 16 may alternatively comprise a T-bar pattern, or any other opening pattern which serves to define a horizontal incision boundary 24. As illustrated in FIG. 2C, the second axis 20 crosses with the first axis 18 to define an incision boundary 24. Hence, the second axis 20 may define either an incision point (FIG. 1C) or an incision boundary (FIG. 2C) at its intersection with the first axis 18. Furthermore, the structure opening may have more than one intersecting axis (i.e. a third axis) such that both the incision point and incision boundary are defined. The horizontal boundary 24 allows users of the present invention to easily and effectively know how close to the mid-line sternum should the preferred location for intercostal access be positioned without any risks of unintended damage to blood vessels, such as the internal mammary artery, organs, or any other surrounding structures. Typically, the horizontal incision boundary will be in the range from about 2.5 cm to about 7.5 cm away from the mid-line sternum. Optionally, the template opening 16 may comprise a groove, notch, or slit in the structure 12.

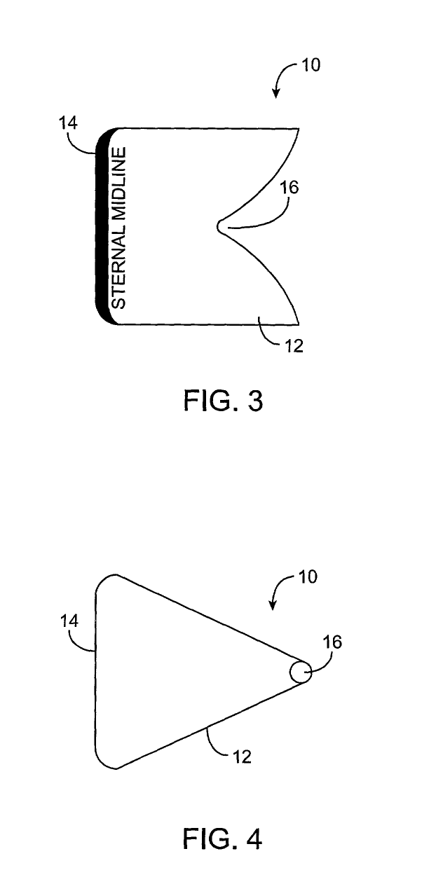

Referring now to FIGS. 3 and 4, still further embodiments of the device of the present invention are illustrated. FIG. 3 illustrates a structure 12 having a marker 14 and a target zone 16. In particular, it will be appreciated that the target zone may be indicated in several fashions. In this depiction, the target zone comprises a V shaped notch or groove which lies over the site when the marker edge or line 14 is aligned with the anatomical feature. FIG. 4 illustrates a wire structure 12 which is suitable for locating a site on a patient's chest for establishing intercostal access to the patient's heart. The wire 12 has an edge 14 and a circular opening 16 which lies over the preferred site after marker 14 alignment.

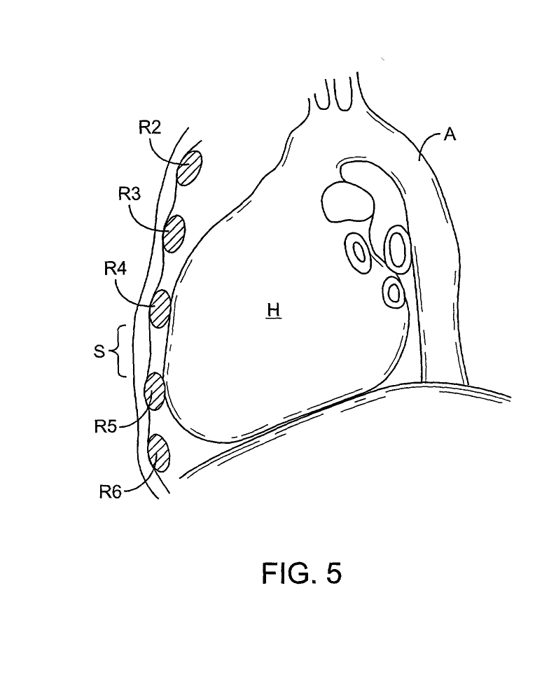

Referring now to FIG. 5, a patient's heart H is shown in a cross-section between ribs Rₙ where n indicates the rib number. The aorta A is also shown extending from the top of the heart.

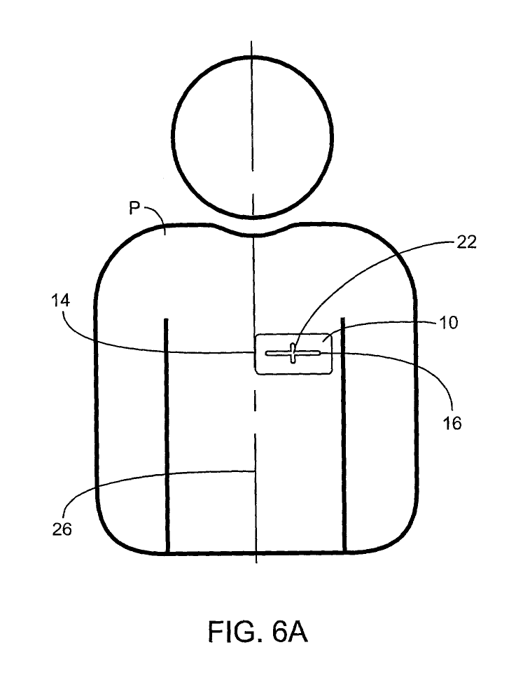

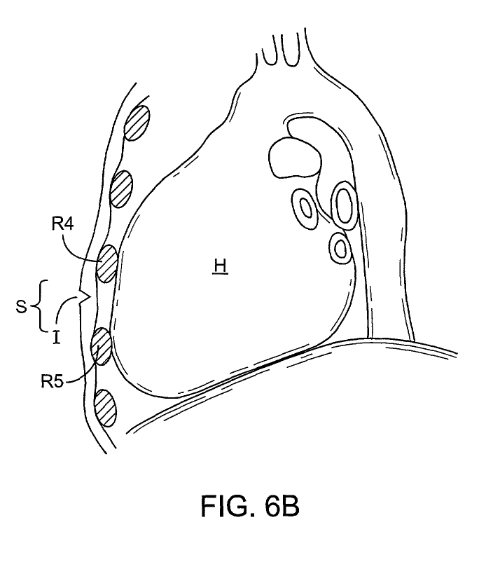

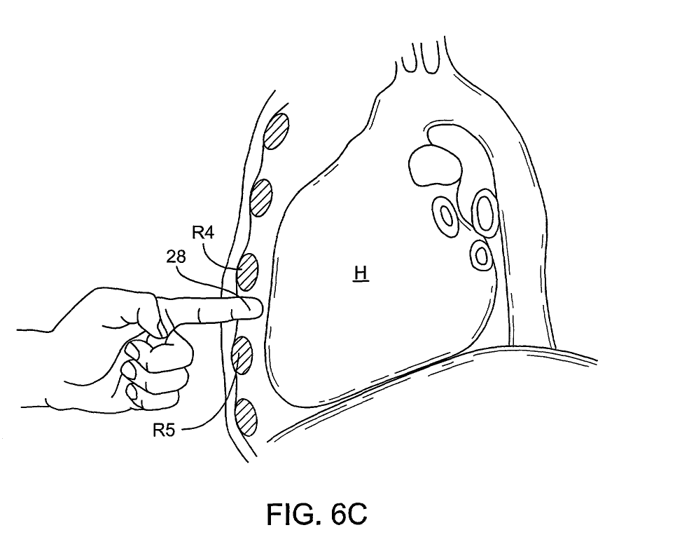

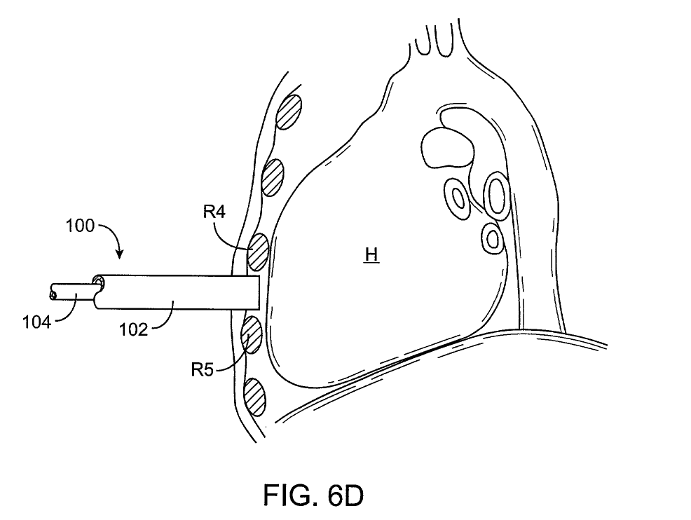

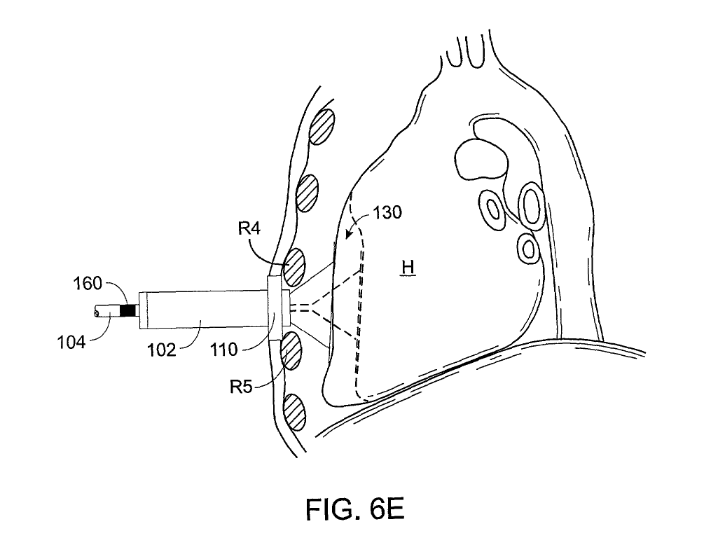

Referring now to FIGS. 6A-6E, a first exemplary method for locating a site S on a patient's chest suitable for establishing percutaneous intercostal access to the patient' heart H with the incision template of FIGS. 1A and 1B will be described. As illustrated in FIG. 6A, at least one marker 14 on a template 10 is aligned with at least one anatomical feature of the patient P, the template 10 having a target zone opening 16 which lies over the site S when the marker 14 is positioned with the anatomical feature. Preferably, a left edge or line 14 of the template 10 is aligned with a sternum mid-line 26 and a template opening 16 over a fourth intercostal space so that the target zone 16 (which also serves as a marker) lies over the site S. In particular, the template opening 16 has a first axis 18 which crosses with a second axis 20 of the template opening to define an incision point 22 for subsequent entry. The incision point 22 at site S will typically be located between ribs R₄ and R₅ of the patient, left of the mid-line sternum 26.

The access site S on the patient's chest as defined by the target zone 16 on the template 10 may be appropriately marked by a treating person with a surgical marker. Optionally, a pre-marked adhesive skin contacting surface on the back or bottom side of the template 10 may be detached on the site S so that there is no need to mark the site with a surgical marker (not shown). Additionally, the adhesive skin contacting surface may form an access patch around the site S after intercostal access. The incision site S and surrounding area may then be prepped using antiseptic, a dispenser cup, gauze, and/or procedure drape.

As shown in FIGS. 6B and 6C, intercostal access may then be achieved by a combination of sharp and blunt dissection. First, a cutting element may be advanced through the site S defined by the target zone 16 so as to make a small incision I or thoracostomy through the skin, fat, and/or muscle layers overlying an outer rib surface. Typically, the incision depth will be in a range from 0.5 cm to about 5 cm, preferably being about 3 cm. The cutting element may comprise a scalpel, surgical knife, lancet, blade, and the like. A blunt member 28 may then be advanced through the intercostal space between ribs R₄ and R₅ above the heart H. The blunt member 28 may comprise a gloved finger of a treating person, as shown in FIG. 6C, a blunt shaft or support, or like structure for clearing access to the heart H and verifying the location of the heart H.

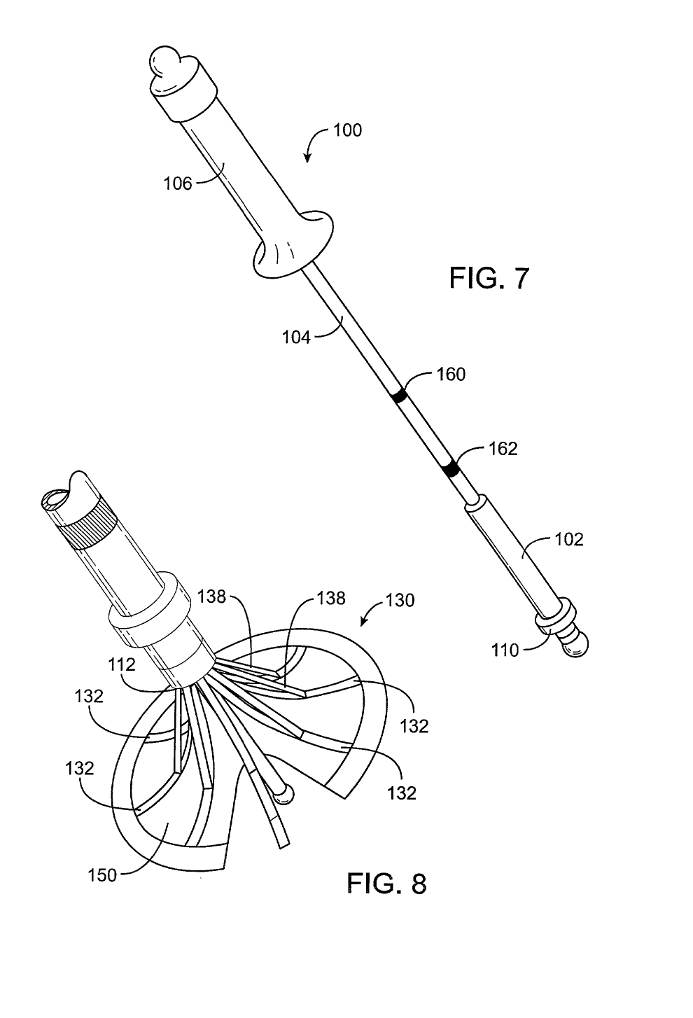

Following intercostal access establishment, a direct cardiac massage device 100 may be advanced as illustrated in FIGS. 6D and 6E. The cardiac massage device 100, as described in more detail in co-pending U.S. patent application Ser. Nos. 09/356,064 and 09/898,701, comprises a sleeve 102, a shaft 104 slidably mounted in a central lumen of the sleeve 102, and a handle 106 attached to a proximal end of the shaft (FIG. 7). The sleeve 102 includes a positioning flange 110 near its distal end, typically spaced proximally of a tip 112 of the device by an optimum distance. A flared bell structure 130, as best seen in FIG. 8, is attached to the distal end of shaft 104 and assumes a trumpeted configuration when fully deployed. The flared bell structure 130 comprises a plurality of outwardly curving struts 132 (the illustrated embodiment has a total of eight struts, but this number could vary). The struts are preferably formed from a resilient metal, usually formed from a superelastic alloy, such as nitinol. To enhance the rigidity and pushability of the structure, re-enforcing beams 138 may also be provided. It has been found that the combination of the curved struts with straight beam supports provides a useful combination of stiffness over the proximal portion of the structure and greater flexibility at the tip portions. The distal tips of the struts 130 are preferably connected by a fabric cover 150 having an edge which is folded over and stitched to hold the cover in place. The fabric cover may be a light mesh, composed of polyester or the like, and will help distribute forces quite evenly over the region of the pericardium which is contacted by the flared bell structure.

Turning back to FIGS. 6D and 6E, the device 100 is pushed through the incision until the flange 110 engages the ribs. Usually, the flared bell structure 130 will have a contracted profile configuration when introduced through the intercostal space. Once the structure is positioned to a region over a pericardium, the flared bell structure 130 is then deployed by advancing shaft 104 until a first marker 160 approaches the proximal end 162 of the sleeve 102. Once the structure 130 is fully deployed, the handle 106 may be manually grasped and the device shaft 104 pumped through the sleeve 102. This will cause the deployed flared bell structure 130 to compress the heart, generally shown in broken line in FIG. 6E. Once resuscitation has been completed, the device 100 may be withdrawn by retracting the shaft 104 relative to the sleeve 102 to draw the structure 130 back into the sleeve. The structure 130 will be sufficiently retraced as soon as the second marker 162 becomes visible out of the proximal end of the sleeve. Once the structure 130 is retracted, the device may be proximally withdrawn through the incision and the incision closed in a conventional manner.

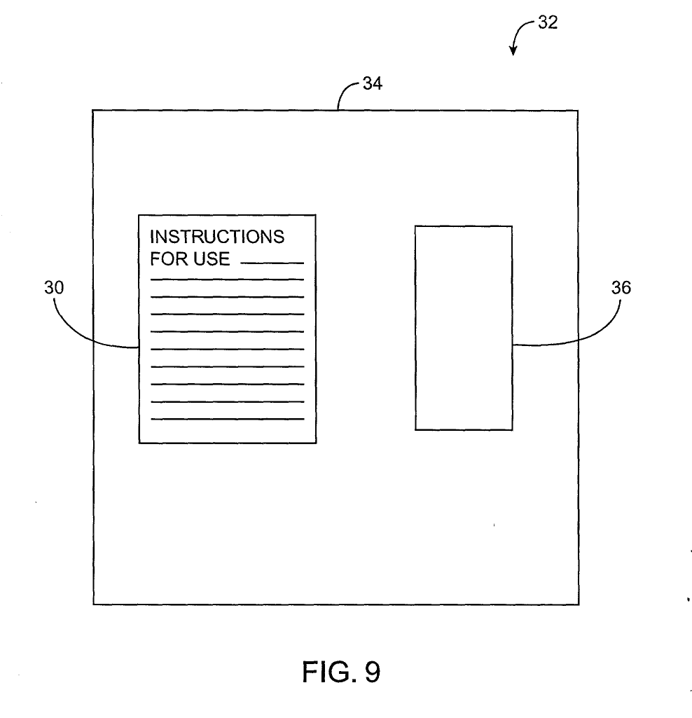

Referring now to FIG. 9, an incision template 10 may be packaged together with instructions for use 30 in a kit 32. A conventional package 34, which may be in the form of a bag, pouch, box, or the like, may be used to contain the template 10 and the instructions for use 30. The template 10 may comprise any of the structures described herein, while instructions for locating a site on a patient's chest suitable for establishing percutaneous intercostal access to the patient's heart will generally recite the steps for performing one or more of the above described methods. The instructions 30 will often be printed on a separate sheet of paper in or on the packaging 34. The instructions 30 may alternatively comprise a videotape, a CD-ROM or other machine readable code, a graphical representation, or the like showing any of the above described methods.

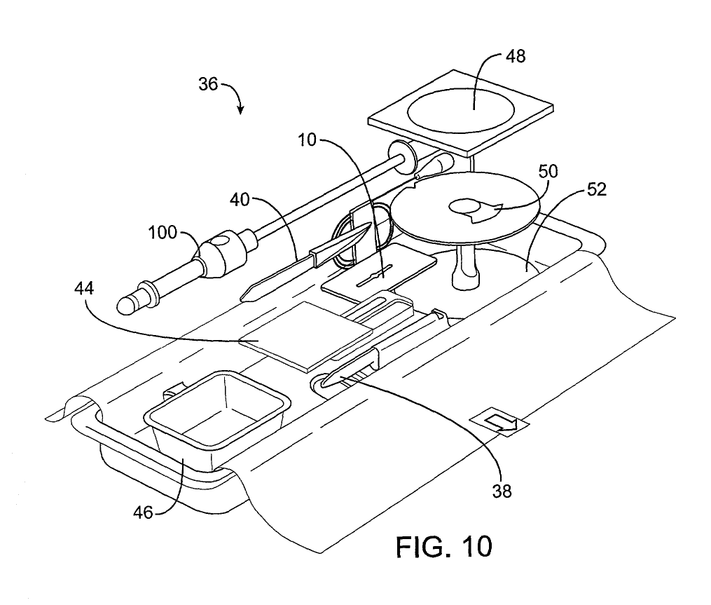

Referring now to FIG. 10, the kit 32 may further comprise a sterile tray 36 holding at least the template 10, a surgical marking pen 38, a scalpel 40, a cardiac massage device 100, gauze 44, a dispenser cup 46, a procedure drape 48, clear view guard 50, or chest seal 52. In particular, the gauze 44, dispenser cup 46, and procedure drape 48 may be used to prep the incision site after it is located with the template 10 and marked with the pen 38. Additionally, a clear view guard 50 may be used to maintain a sterilized environment for both the patient and an operator of the device. A chest seal 52 may be applied to the incision site after a procedure to allow venting of the chest, typically in one directional fashion where air is vented out but not back in. Still optionally, the template 10 and the surgical marking pen 38 may be provided outside the sterile tray 36 in the package 34 or bag (not shown).

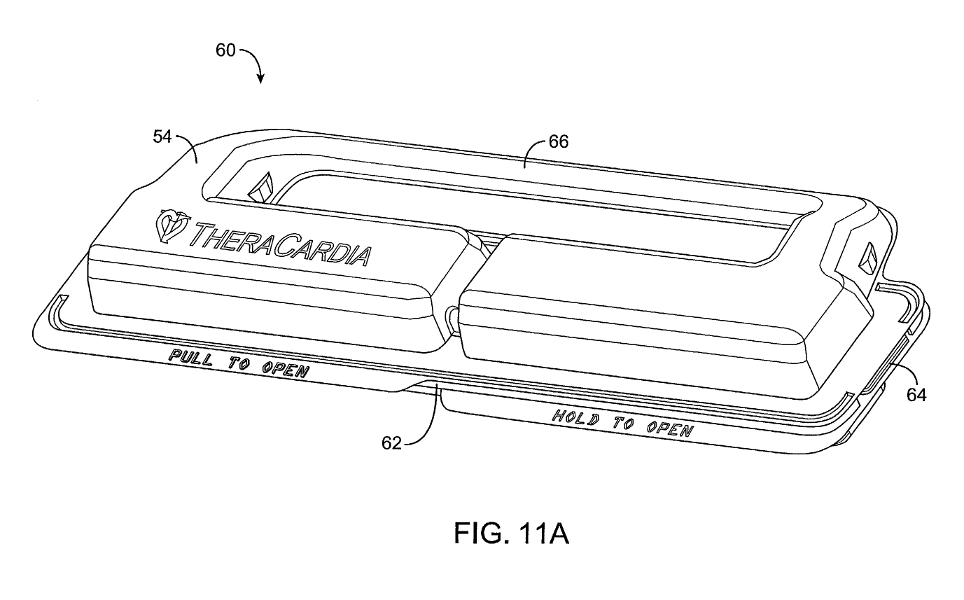

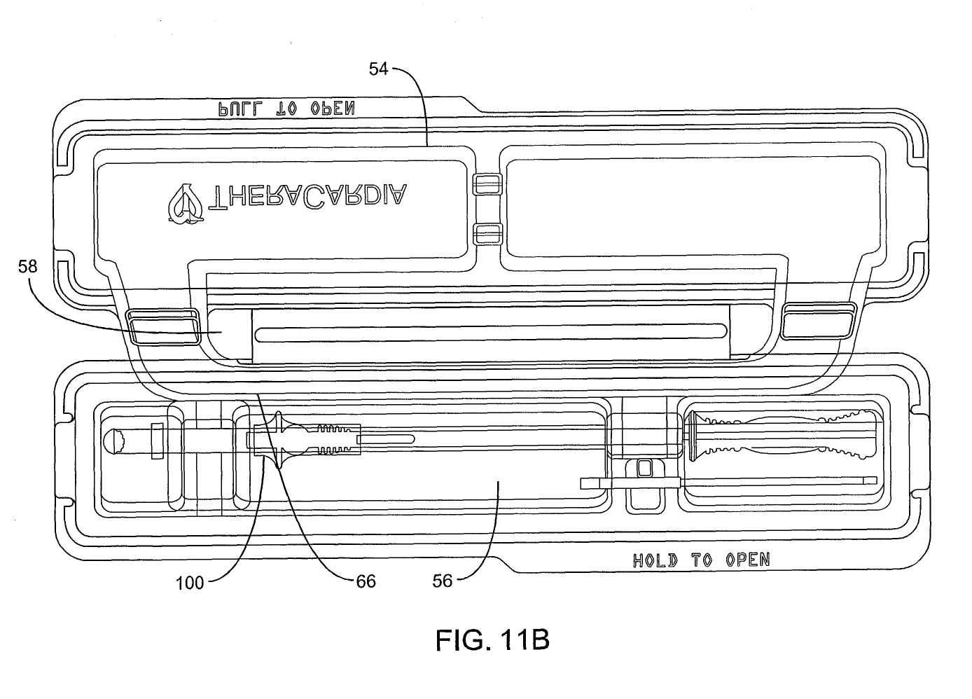

Referring now to FIGS. 11A and 11B, the kit 32 may alternatively further comprise a first sterilized tray 56, holding the incision template 10 and a cardiac massage device 100, and a second non-sterilized tray 54, holding at least a surgical marking pen 38, scalpel 40, gauze 44, dispenser cup 46, procedure drape 48, clear view guard 50, or chest seal 52. The first 56 and second tray 54 may be hinged 58 together to form a single unit 60. There may be an interlock seal 62 around a perimeter between the trays 54 and 56 so that each sealed area 64 of the trays are protected from outside exposure when the unit 60 is closed. Additionally, a tray handle 66 may be integrally formed with the second tray 54, which may half lock into an undercut of the first tray 56 when the unit 60 is opened. The handle 66 allows for easy transportation of the unit 60 and also acts as hinge lock when the unit 60 is opened (thereby preventing the hinge 58 from collapsing). Generally, this hinged single unit 60 of two separate trays 54 and 56 provides many manufacturing benefits. For example, pre-packaged components (e.g. pen 38, scalpel 40, etc.) may be easily combined with other custom components (e.g. template 10, device 100, etc.) that may require separate sterilization in two separate trays that may be simply locked together to form a single unit. This in turn may decrease manufacturing scrap rate, production costs, and allow flexibility with respect to which pre-packaged components may be combined with device 100. Moreover, the hinged unit 60 is compact so that the kit may be easily stored in an ambulance where space constraints are often a concern.

Although certain preferred embodiments and methods have been disclosed herein, it will be apparent from the foregoing disclosure to those skilled in the art that variations and modification of such embodiments and methods may be made without departing from the true spirit and scope of the invention. Therefore, the above description should not be taken as limiting the scope of the invention which defined by the appended claims.

What is claimed is:

1. A method for locating a site on a patient's chest suitable for establishing percutaneous intercostal access to the patient's heart, the method comprising:
aligning at least one marker on a template with at least one anatomical feature of the patient, the template having a target zone which lies over the site when the marker is aligned with the anatomical feature.

2. A method as in claim 1, wherein aligning comprises aligning a first marker with a mid-line of the patient's sternum.

3. A method as in claim 2, wherein aligning further comprises aligning a second marker on the template with a fourth intercostal space.

4. A method as in claim 1, wherein aligning comprises aligning a left edge of the template with a mid-line of the patient's sternum and a template opening over a fourth intercostal space.

5. A method as in claim 1, further comprising choosing a template dependent upon patient characteristics prior to alignment.

6. A method as in claim 1, wherein the target zone comprises an opening, groove, notch, or slit in the template.

7. A method as in claim 6, wherein the template opening has a cross-like pattern.

8. A method as in claim 6, wherein the template opening has a T-bar pattern.

9. A method as in claim 6, further comprising defining a horizontal incision boundary with the template opening.

10. A method as in claim 6, further comprising defining an incision point with the template opening.

11. A method as in claim 10, wherein the incision point is between a fourth and fifth rib.

12. A method as in claim 10, wherein the incision point is left of a mid-line sternum.

13. A method as in claim 1, further comprising detaching an adhesive skin contacting surface of the template on the site so as to form an access patch.

14. A method as in claim 1, further comprising marking the site defined by the target zone with a surgical marker.

15. A method as in claim 14, further comprising prepping the site.

16. A method as in claim 15, further comprising advancing a cutting element through the site defined by the target zone so as to make a small incision through skin overlying an intercostal space and then advancing a blunt member through the intercostal space above the heart.

17. A method as in claim 16, further comprising clearing the access to the heart and verifying the location of the heart with the blunt member.

18. A method as in claim 17, further comprising advancing a direct cardiac massage device following intercostal access establishment.

19. A method for locating a site on a patient's chest suitable for establishing percutaneous intercostal access to the patient's heart, the method comprising:
aligning a left edge of a template with a mid-line of the patient's sternum; and
aligning an opening in the template with a fourth intercostal space;
wherein a target zone of the template lies over the site following alignment of the template.

20. An improved method for establishing intercostal access to a patient's heart, the improvement comprising aligning a template with an anatomical feature of the patient and penetrating an instrument through tissue between the patient's ribs at a site determined by the template.

21. An incision template comprising:
a structure placeable on a patient's chest, wherein the structure has at least one marker which can be aligned with at least one anatomical feature of the patient and a target zone which lies over a preselected location for intercostal access when the marker is aligned with the anatomical feature.

22. An incision template as in claim 21, wherein the structure comprises a card or wire structure.

23. An incision template as in claim 21, wherein two markers together define the preselected location for intercostal access.

24. An incision template as in claim 21, wherein the marker comprises an edge, hole, or line on the structure.

25. An incision template as in claim 21, wherein the marker is alignable with a mid-line of a sternum, an intercostal space, a rib, or a nipple of the patient.

26. An incision template as in claim 21, wherein the template target zone lies over a skin surface over a fourth intercostal space when the marker is aligned with the anatomical feature.

27. An incision template as in claim 21, wherein the target zone comprises an opening, groove, notch, or slit in the structure.

28. An incision template as in claim 27, wherein the opening has a cross-like pattern.

29. An incision template as in claim 27, wherein the opening has a T-bar pattern.

30. An incision template as in claim 27, wherein a first axis of the structure opening crosses with a second axis of the structure opening to define a horizontal incision boundary.

31. An incision template as in claim 27, wherein a first axis of the structure opening crosses with a second axis of the structure opening to define an incision point.

32. An incision template as in claim 21, wherein a back side of the structure has a detachable adhesive skin contacting surface which forms an access patch.

33. An incision template for locating a site of percutaneous intercostal access, the template comprising:
a flat-sided body having an opening extending between opposite flat sides of the body, the body being positionable against a skin surface of an intercostal space so that the opening defines the site suitable for subsequent intercostal access.

34. A kit comprising:
an incision template; and
instructions for use setting forth a method comprising aligning a marker on the template with an anatomical feature of a patient, the template having a target zone which lies over a site when the marker is positioned with the anatomical feature so that the target zone defines the site for subsequent intercostal access.

35. A kit as in claim 34, further comprising a first tray holding the incision template and a cardiac massage device.

36. A kit as in claim 35, further comprising a second tray holding at least a surgical marking pen, scalpel, gauze, dispenser cup, procedure drape, clear view guard, or chest seal.

37. A kit as in claim 36, wherein the first and second trays are independently sterilizable.

38. A kit as in claim 36, wherein the first and second trays are hinged together to form a single unit.

39. A kit as in claim 36, further comprising a tray handle integrally formed with the first or second tray.

40. A kit as in claim 34, further comprising a tray holding at least the incision template, a surgical marking pen, a scalpel, a cardiac massage device, gauze, a dispenser cup, a procedure drape, a clear view guard, or a chest seal.

41. A kit as in claim 40, wherein the tray is sterile.

42. A kit as in claim 34, further comprising a non-sterile bag holding the template and a surgical marking pen.
